(19) United States
(12) Patent Application Publication
(10) Pub. No.: US 2002/0079152 A1
(43) Pub. Date: Jun. 27, 2002

(54) Apparatus for retaining a battery within a motor vehicle

(76) Inventors: James E. Van Hout, Auburn Hills, MI (US); Gregory Denomy, Markham (CA); Ernst Von Schlager, Novi, MI (US)

Correspondence Address: Mark P. Calcaterra, DaimlerChrysler Intellectual Capital Corporation, CIMS 483-02-19, 800 Chrysler Drive, Auburn Hills, MI, 48326-2757, US

(21) Appl. No.: 09/879,015

(22) Filed: Jun. 11, 2001

Related U.S. Application Data
(63) Continuation-in-part of application No. 09/749,647, filed on Dec. 27, 2000.

(51) Int. Cl. B60R 16/04

(52) U.S. Cl. 180/68.5

(57) ABSTRACT

A device for selectively retaining a battery. The device further allows for retention of either the European configuration or the American configuration. The device accomplishes this through the use of a locating feature, an attachment and a dual sided locating head. In the first position, the device is positioned along the mounting ledge and the battery tray. In this position, the device selectively retains American configuration batteries. In a second position, the same device is flipped over to provide a clamp for the European style batteries. In this configuration, the opposite side of the locking head is in contact with the mounting ledge of the battery, which is of different shape and position as the American battery. The versatility of the device allows for the transfer of an American battery with a European battery and vice-versa.

### CROSS-REFERENCE TO RELATED APPLICATIONS

This application is a continuation-in-part of U.S. patent application Ser. No. 09/749,647, filed Dec. 27, 2000.

### FIELD OF THE INVENTION

The present invention generally pertains to motor vehicles. More particular, the present invention pertains to an apparatus for retaining a battery within a motor vehicle. More specifically, but without restriction to the particular embodiment and/or use which is shown and described for purposes of illustration, the present invention relates to an apparatus for selectively retaining various types of batteries within a motor vehicle. The method also relates to a method of selectively securing various types of batteries with a common retainer.

### BACKGROUND OF THE INVENTION

It is common for motor vehicles with an internal combustion engine to include an electric storage battery for providing starting, lighting and ignition functions. Two common styles of batteries exist for use in automotive applications, European and American. The American style of automotive battery is shown in FIG. 2. The European style of automotive battery is shown in FIG. 3.

Both common styles of vehicle batteries have similar electrical properties. Insofar as the present invention is concerned, the difference between the American and European Batteries reside within the shape and location of the mounting lugs. The American style battery utilizes an downwardly angled ledge that protrudes from the elongated side of the battery. The European style battery similarly utilizes a downwardly angled ledge. However, the mounting ledge of the European style battery is at a higher distance from the bottom of the battery and at a different angle.

A conventional description 10 for securing an automobile battery to a battery tray in a vehicle is illustrated in FIG. 1. The clamp 10 is particularly adapted for securing a conventional American style battery 20, shown in FIG. 2. A device similar to clamp 10 having a modified configuration may be used to secure a European battery 30, such as shown in FIG. 3. Domestic battery 20 is a lead acid battery typically found in automotive applications. Battery 20 includes a ledge or mounting lug 22 located at a specified height along one side 24. Mounting lug 22 generally includes a seating surface 26 which angles downwardly from a housing of the battery 20.

European battery 30 is also a lead acid battery typically found in automotive applications. Battery 30 includes a mounting ledge or lug 32 located at a height greater than the specified height of battery 20 along one side 34. Mounting lug 32 includes a seating surface 36 that angles downwardly from a housing of the battery 30. One other difference between the two styles of batteries is the distance between the bottom of the battery and the respective angled seating surface.

While known devices for retaining batteries within a motor vehicle have proven to be commercially acceptable for their intended purposes, they are all associated with limitations. In this regard, the globalization of the automobile industry has allowed manufacturers to produce a vehicle of one design and sell it in many different areas. It is conceivable that a vehicle that was designed or produced in Europe could be sold in the Americas or vice-versa. Known devices for retaining batteries within a motor vehicle do not allow for a vehicle to be fitted with a battery matching the style of battery that is prevalent in the selling area without the use of separate retainers for each battery. The utilization of a single retainer would also reduce complexity and cost of the design and assembly process. Furthermore, the life of an automobile battery is often less than the life of the vehicle. Therefore, the expired battery is required to be replaced with a new one. It is typically not known when and where a vehicle battery will expire. Known devices for retaining batteries within a motor vehicle do not allow for the effective retention of American or European batteries as replacement batteries where the opposite style of battery was originally provided without requiring separate retention devices.

It remains desirable in the relevant art given the similarities between the European and American battery styles to provide a device that can selectively secure both styles of batteries.

### SUMMARY OF THE INVENTION

It is a general object of the present invention to provide a battery retention device that is universally applicable for European and American styles of batteries. Such a device would allow the interchangeability of battery styles.

In one form, the present invention provides an apparatus for selective retaining a first type of battery and a second type of battery within a motor vehicle. The first type of battery has a mounting ledge with an angled upper surface oriented at a first angle relative to the horizontal and disposed a first distance from a bottom of the first type of battery, the second type of battery having an mounting ledge with upper surface oriented at a second angle relative to the horizontal and disposed a second distance from a bottom of the second type of battery. The apparatus generally includes a main body portion, a locating portion and a head. The main body portion attaches to a battery tray. The locating portion positions the apparatus horizontally relative to the tray and one of the batteries. The head has first and second angled engaging surfaces for selectively engaging the angled upper surface of the first type of battery and the angled upper surface of the second type of battery, respectively.

Additional benefits and advantages of the present invention will become apparent to those skilled in the art to which this invention relates from a reading of the subsequent description of the preferred embodiment and the appended claims, taken in conjunction with the accompanying drawings.

### BRIEF DESCRIPTION OF THE DRAWINGS

The present invention will become more fully understood from the detailed description and the accompanying drawings, wherein:

FIG. 1 is a perspective view of a prior art apparatus for retaining a particular type of battery within a motor vehicle.

FIG. 2 is a perspective view of a first type of known battery for a motor vehicle, the first type of known battery being common within the Americas.

FIG. 3 is a perspective view of a second type of known battery for a motor vehicle, the second type of known battery being common in Europe.

FIG. 4 is perspective view of an apparatus for maintaining a battery within a motor vehicle constructed in accordance with the teachings of a preferred embodiment of the present invention.

FIG. 5 is a partial sectional view illustrating the apparatus of FIG. 4 securing the battery of FIG. 2 to a battery tray.

FIG. 6 partial sectional view illustrating the apparatus of FIG. 4 securing the battery of FIG. 3 to a battery tray.

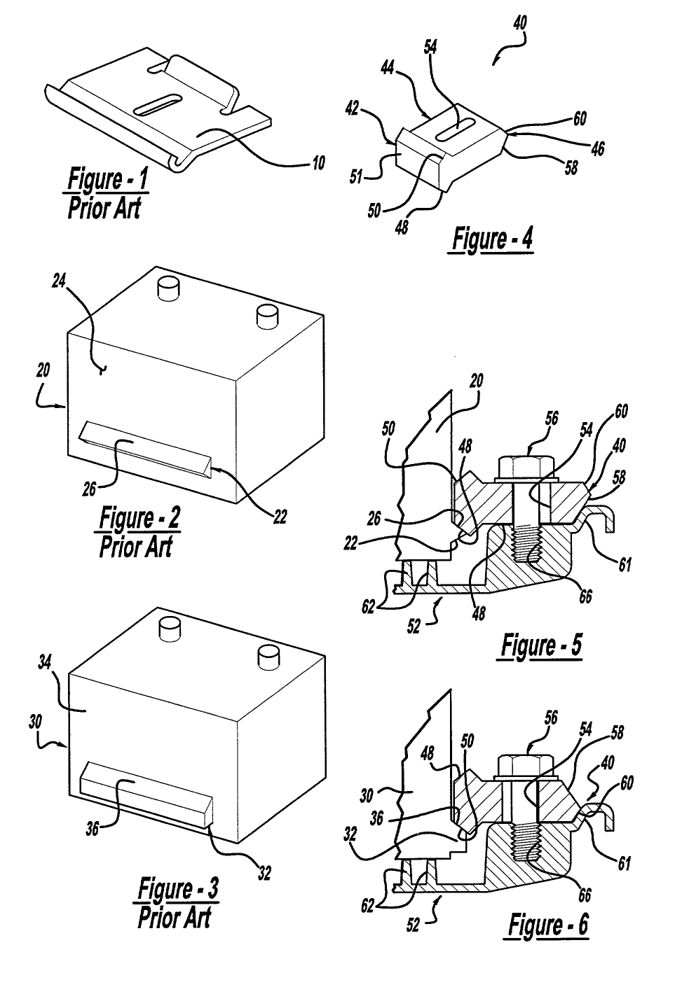

### DETAILED DESCRIPTION OF THE PREFERRED EMBODIMENTS

With continued reference to FIGS. 2 and 3 and additional reference to FIGS. 4-6, an apparatus for selectively securing one of a first type of battery and a second type of battery within a motor vehicle is illustrated and generally identified at reference number 40. The partial sectional view of FIG. 5 shows the apparatus 40 operatively associated with the conventional American battery 20 of FIG. 2. The partial sectional view of FIG. 6 shows the apparatus 40 operatively associated with the conventional European battery 30 of FIG. 3.

Apparatus 40 is preferably made of a rigid, durable, and environmentally stable material such as plastic or metal. However, those skilled in the art will appreciate that any material having requisite strength and durability may be employed within the scope of the present invention.

Retainer 40 is illustrated to generally include a head 42, a body 44 and a locating portion 46. Head 42, functions to locate retainer 40 relative to the mounting lug 22 or 32 of one of the types of batteries 20 or 30. Apparatus 40 is shown to preferably include first and second angled surfaces 48 and 50 connected by a vertical surface 51. First angled surface 48 is preferably at a supplementary angle to angled surface 26 of lug 22. Similarly, second angled surface 50 is preferably at a supplementary angle to angled surface 36 of lug 32. As will become more apparent below, apparatus 40 is properly oriented for use with American battery 20 when first surface 48 of head 42 is located against seating surface 26 on mounting lug 22. Further, apparatus 40 is properly oriented for use with European battery 30 when second surface 50 of head 42 is located against seating surface 36 of mounting lug 32.

Body 44 of apparatus 40 provides an attachment location to a battery tray 52 through a slot 54. It will be understood that insofar as the present invention is concerned, tray 52 is conventional in construction. Slot 52 is horizontally elongated and extends vertically through body 44 allowing for adjustable locating of retainer 40 in a horizontal direction with a threaded fastener 56.

Locating portion 46 is generally triangular in shape and includes two angled surfaces 58 and 60. Depending on the particular orientation of apparatus 40, surfaces 58 and 60 engage an angled flange 61 of battery tray 52. Such engagement positions apparatus 40 horizontally to properly engage one of American battery 20 and European battery 30. In one particular application, angled surface 48 is oriented approximately 330 from the horizontal and angled surface 50 is oriented approximately 330 from the horizontal.

As particularly shown in FIG. 5, the apparatus 40 of the present invention is shown generally in the orientation of FIG. 4. In this orientation, first angled surface 48 faces downwardly. American battery 20, is seated in battery tray 52. A plurality of ribs 62 are conventionally located at the bottom of battery tray 52 for vertically supporting American battery 20. Apparatus 40 is oriented such that first angled surface 48 faces downwardly for engaging angled surface 26 of lug 22. Angled surface 58 engages flange 61. Threaded fastener 56 is installed through slot 52 in apparatus 40 and engages a threaded aperture 66 in battery tray 52.

With particular reference to FIG. 6, apparatus 40 of the present invention is shown in the second orientation. Battery 30, is seated in battery tray 52. Apparatus 40 is positioned such that second angled surface 50 faces downwardly for engaging angled surface 36 of lug 32. Angled surface 50 engages flanges 61 so that surface 48 is adjacent to surface 66 providing proper height for surface 48 of head 42 to locate surface 26 on mounting lug 22. Again, threaded fastener 56 is installed through slot 52 and engages threaded aperture 66 in battery tray 52 to releasably secure retainer 40 to battery tray 56.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the description of the appended claims.

What is claimed is:

1. An apparatus for selective retaining a first type of battery and a second type of battery to a battery tray within a motor vehicle, the first type of battery having a mounting ledge with an angled upper surface oriented at a first angle relative to the horizontal and disposed a first distance from a bottom of the first type of battery, the second type of battery having a mounting ledge with an upper surface oriented at a second angle relative to the horizontal and disposed a second distance from a bottom of the second type of battery, the apparatus comprising:
a main body portion for interconnection to the battery tray;
a locating portion for positioning the apparatus horizontally relative to the tray and one of the first and second types of batteries; and
a head having a first and second angled engaging surfaces for selectively engaging the angled upper surface of the first type of battery and the angled upper surface of the second type of battery, respectively.

2. The apparatus for selectively retaining a first type of battery and a second type of battery within a motor vehicle of claim 1, wherein the locating portion is formed by two intersecting angled surfaces extending from said main body.

3. The apparatus for selectively retaining a first type of battery and a second type of battery within a motor vehicle of claim 1, wherein the main body portion includes a slot vertically therethrough for receiving a threaded fastener.

4. The apparatus for selectively retaining a first type of battery and a second type of battery within a motor vehicle of claim 1, wherein the first angled surface is at a supplementary angle to the angled upper surface of the first battery type.

5. The apparatus for selectively retaining a first type of battery and a second type of battery within a motor vehicle of claim 1, wherein the second angled engaging surface is at a supplementary angle to the angled upper surface of the second battery type.

6. The apparatus for selectively retaining a first type of battery and a second type of battery within a motor vehicle of claim 1, wherein the first and second angled engaging surfaces are oriented at distinct angles relative to the horizontal.

7. A motor vehicle comprising:
one of a first type of battery and a second type of battery, the first type of battery having a mounting ledge with an upper surface oriented at a first angle relative to the horizontal upper surface, the second type of battery having a mounting ledge with upper surface oriented at a second angle relative to the horizontal, the first angle being different than the second angle;
an apparatus for selectively securing the one of the first and second types of batteries to the battery tray, the apparatus including:
a head having first and second angled engaging surfaces for selectively engaging the angled upper surface of the first type of battery and the angled upper surface of the second type of battery, respectively;
a main body portion secured to the battery tray with a fastener; and
a locating portion positioning the apparatus horizontally relative to the tray and the one of the first and second types of batteries.

8. The motor vehicle of claim 7, wherein the locating end is formed by two intersecting angled surfaces extending from the main body.

9. The motor vehicle of claim 7, wherein the main body portion defines an aperture.

10. The motor vehicle of claim 8, wherein the first angled engaging surface is at a supplementary angle to the angled upper surface of the first battery type.

11. The motor vehicle of claim 7, wherein said lower engaging face is constructed at a supplementary angle to the angled upper surface of the second battery type.

12. The motor vehicle of claim 11, wherein said lower engaging surface is constructed at an offset distance as compared to said upper engaging surface.

13. A method of selectively securing one of a first type of battery and a second type of battery within a battery storage area of a motor vehicle, the first type of battery including a mounting ledge with an angled upper surface, the second type of battery including an mounting ledge with upper surface angled differently than the first battery and located a greater distance from the bottom edge than the first battery, the method comprising the steps of:
providing an apparatus for selectively retaining either of the first or second type of battery within the battery storage area; and
orienting the apparatus in a first position to retain one of the first type of battery or the second type of battery within the battery storage area.

14. The method of claim 13, further comprising the steps of:
selectively placing the other of the first type of battery or the second type of battery within the battery storage area;
orienting the apparatus in a second position to retain the other of the first or second types of batteries within the battery storage area.
